(19) United States
(12) Patent Application Publication
(10) Pub. No.: US 2004/0012485 A1
(43) Pub. Date: Jan. 22, 2004

(54) Price label system

(76) Inventor: David Sundqvist, Knivsta (SE)

Correspondence Address: YOUNG & THOMPSON, 745 SOUTH 23RD STREET 2ND FLOOR, ARLINGTON, VA, 22202

(21) Appl. No.: 10/332,268

(22) PCT Filed: Jul. 6, 2001
(86) PCT No.: PCT/SE01/01561

(30) Foreign Application Priority Data
Jul. 7, 2000 (SE) 0002574-2

(51) Int. Cl. H04Q 1/00

(52) U.S. Cl. 340/5.91

(57) ABSTRACT

A price label system includes a price label system server adapted to communicate with a price controlling application (PCA) server communicating price label information to price labels (PLs), wherein the characteristics of a price label depend on price label types, price label layout scripts and price label models. The system includes a price label product, being a representation of a physical price label, that links together the price label type, price label layout script and price label model for a specific price label.

### FIELD OF THE INVENTION

The present invention relates to a price label system according to the preambles of the independent claims.

### BACKGROUND OF THE INVENTION

The price label system according to the present invention is generally an electronic pricing and information system that replaces the old paper labels with electronic labels where the prices on labels can be wirelessly changed from, a computer.

The actual price changes are not done in the price label system, but in the store's Price Controlling Application (PCA) system. The PCA contains a database which stores all the information about the items in the store, e.g. product name, package size, and the current price. The store's cash registers are connected to the PCA system, and thus always have the correct price information. The PCA can e.g. be the store's back-office computer system. There are no limitations regarding host computers for the PCA and the price label system server. They may be run on the same computer or in two (or more) different computers.

The PCA system controls the actual price of an item and provides the price label system according to the invention with updating information whenever the price is changed. The PCA system interacts with the price label system to supply information to the price labels (PLs). This is normally performed via a Price File Interface (PFI) that is a software-to software interface connecting the PCA system to the price label systemserver. The only prerequisite is that all PFI files (see below) are reachable (can be read and written) within any path of a mounted drive or file system known to the computer where the PFI service is executing. The transportation mechanisms through the PFI are e.g. common text files, e.g. in 8-bit ASCII format or 2-byte UNICODE. Other transportation mechanisms are naturally possible. The price label system automatically detects the format of the input files. Two PFI files are created by the PCA, a message file and a data file.

The price label system creates a third PFI file, a result file that is retrieved by the PCA.

The message file contains one or many commands to the price label, e.g. a target link command used to establish the connection between an item and a label and an update command used to change the information an the label, e.g. the price. The data file contains data such as prices, item identity and label identity and the result file contains the results from executed commands.

The price label system generally comprises software installed in a server computer, a hardware infrastructure and price labels. The hardware infrastructure comprises base stations, transceivers and cables. The price labels are mounted with their items in the store, e.g. on the shelf-edges. Transceivers are normally mounted in the ceiling and base stations normally on a wall. A predetermined number of transceivers are connected to a base station, which is connected to the price label system server, preferably via a hub. The price label server is connected to the PCA, often via the same network.

FIG. 1 schematically illustrates an overview of the PCA and the price label system briefly described above and in accordance with well-established technique where the present invention is applicable.

When a price is changed in the PCA system, the information is sent to the price label system server (PLS server). From the PLS server, designated as “server” in FIG. 1, the information is sent via a hub and base stations BS to transceivers in the ceiling where it is transformed into infrared signals. When the electronic price labels receive the infrared signals the price is immediately updated.

Each electronic price label acknowledges the updated price by transmitting a feedback pulse to the transceivers. The feedback pulse is returned to the server and stored in a database to verify that the transmission was OK.

Although the system shown in FIG. 1 uses infrared signals when communicating with the price label it should be noted that the present invention is equally applicable for any type of communication signal used between the price label system and labels.

Among different types of communication signal applicable in the system can be mentioned radio wave signals, optical signals, electrical signals.

A cell is defined as the set of transceivers connected to the same base station. A sub-cell is defined as each set of simultaneously transmitting transceivers. All transceivers within a sub-cell simultaneously transmit the same data. A power supply energizes the transmitting transceivers.

FIG. 2 illustrates an example of an installation plan with one cell comprising three sub-cells, SC1, SC2 and SC3, respectively. Each sub-cell includes a number of transceivers TRX. When configuring cells and sub-cells many different things must be considered. Among those can be mentioned that cables to transceivers within one sub-cell must be of similar lengths in order to minimize phase shifts and that sub-cells should overlap in order to ensure signals of sufficient strengths to all labels.

A benefit of the sub-cell concept is that it is possible to keep track of price label locations and that a label that does not respond can be paged (searched for).

A price label (PL) is an electronic device provided with an LCD display with the shape and size of a regular shelf-edge price label. Each PL has a unique address and is logically connected to a sales item in the store. Normally the PL displays an item's price. FIG. 3a shows a typical price label where an fields are active and FIG. 3b shows a price label displaying normal price and normal unit price. A sender and transmitter part 2 and a small solar cell 4 can also be seen on the price label in FIG. 3b. A battery, or a combination of battery and solar cell, provides the power for the PL.

There exists many different kinds of price labels, they can e.g. differ in size, in number of price fields or other fields. The word “price” is used throughout the application to define what is displayed on the price label. It should however be noted that although the price label often displays price information it is naturally possible to display other type of information on the price labels, solely or in addition to price information, without departing from the scope of the present invention. This other type of information may for example be text, figures or images.

The labels can also differ in the way the price label system needs to handle them, e.g. with regard to used communication protocol, and if the circuitry inside the price label has been changed.

The object of the present invention is to further increase the performance of the price label system. In particular how the price label system is intended to be used by the user, or, in other words, to provide a system having possibilities for the user to be able to a large extend tailor in a user-friendly environment the displayed information of the price label(s).

Another object of the invention is to achieve a price label system that is easy to update both regarding software and hardware, by the system provider without influencing the performance of the system.

### SUMMARY OF THE INVENTION

The above-mentioned object is achieved by a price label system according to the characterizing portions of the independent claims. Preferred embodiments are set forth in the dependent claims.

Thus, by arranging a price label product (PL product) object that tights the PL types, PL models and PL layout scripts together the above-mentioned object is achieved.

PL product makes it possible to add PL type without altering layout script or model.

### SHORT DESCRIPTION OF THE APPENDED DRAWINGS

FIG. 1 is a schematic illustration of a price controlling application system and a price label system according to weU-established technique where the present invention is applicable.

FIG. 2 illustrates an example of an installation plan for transceivers.

FIGS. 3a and 3b shows typical price labels used by the system according to the invention.

FIG. 4 a simplified illustration of a preferred embodiment of the present invention.

FIG. 5 illustrates that different PL models may be used for different PLs for the same item.

FIG. 6 shows a detailed block diagram illustrating the relationships between different hardware and software objects according to the present invention.

FIG. 7 shows the main blocks of the price label system according to the present invention.

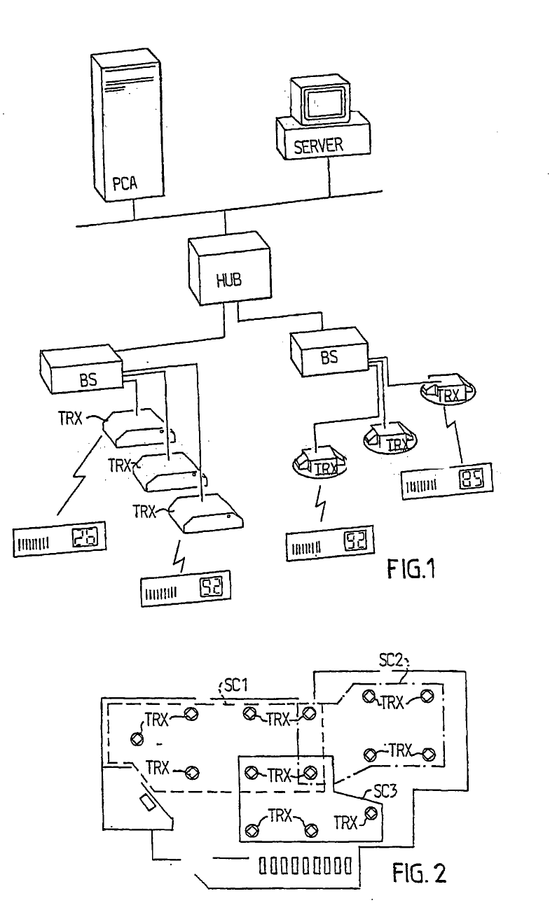

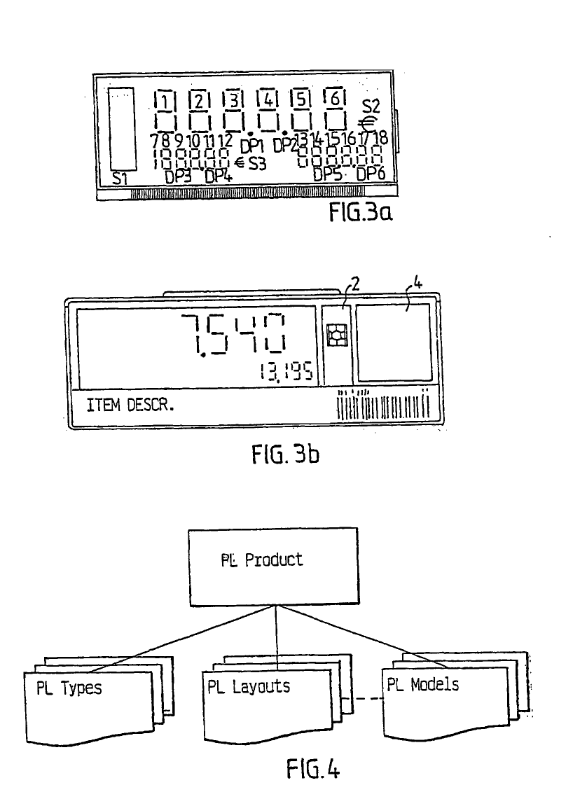

### DETAILED DESCRIPTION OF PREFERRED EMBODIMENTS OF THE INVENTION

Definitions of different objects used to define a price label are provided below. These objects may be tables, databases and in particular relational databases.

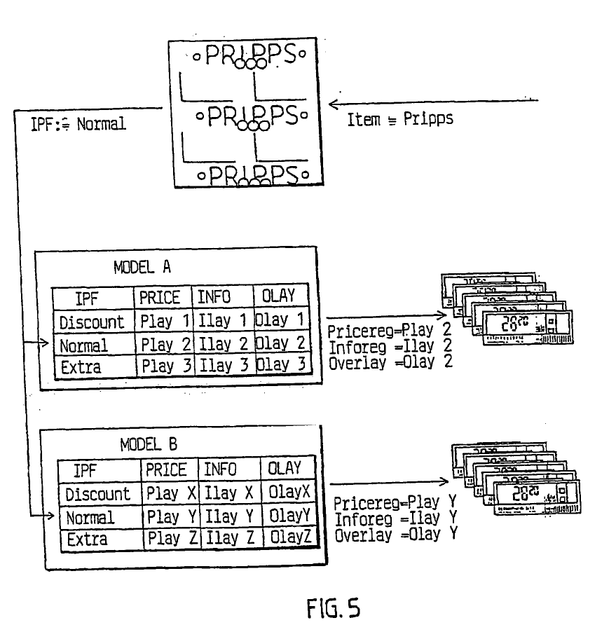

FIG. 4 is a simplified illustration of a preferred embodiment of the present invention where the relation between a price label product (PL product) and price label types (PL types), price label layout scripts (PL layout) and price label models (PL models) is shown. A detailed description of these objects is given in the following.

Price label type (PL type) describes the physical characteristics for a price label, e.g. communication protocol parameters and LCD display segments and how they are grouped. The characteristics of a PL type are described in a device file

Price label layout (PL layout) specification describes how to map item data on the label. A PL layout script that configures how to map data onto a specific PL type performs this. The script is defined in a layout script file that is compiled by the system at start-up. Since the layout script is compiled every time the system starts, it is possible to modify the script at the customer site. The PL layout script is written in an easy-to-use programming language that specifies down to the bits and bytes how data should be presented on a PL type. Each segment of the PL display is possible to control.

Price label model (PL model) contains information about how to apply information sent to the system over e.g. the PFI to the labels. The PL model contains information about layout scripts to use for different Item Presentation Forms (see below). An overlay is an optionally used paper that is attached to the label's front end. The overlay may comprise information about the item, such as name, brand and weight.

An Item Presentation Form (IPF) is an abstraction of what information to display on a PL for an Item. It is passed as an Item property by the PCA. Thus it isolates the PCA from the PL layout scripts handled internally by the price label system according to the invention. The references between IPF and PL layout scripts are kept within the PL model.

The IPF may e.g. be “normal price” or “discount price” and is used as a pointer for different PL models for the same item. In FIG. 5 the IPF is defined and, points in both used PL models at “normal price”. The both used PL models may represent different sized price labels used for the same item e.g. showing two and three price fields, respectively. Thus, it may happen that the same IPF (e.g. “normal price”) points at different PL layout scripts when used in different models.

In the earlier systems each PL type was directly associated to a PL model or PL layout script. When a new PL type, e.g. new circuitry in a price label, all PL models and PL layout scripts using that specific PL type had to be changed which was a lengthy and sometimes cumbersome procedure.

In the price label system according to the present invention using PL products new PL types can be added without influencing the PL models or layout scripts. The advantage of that is that the PL types can be handled separately e.g. be handled by the supplier of the price label system, whereas PL layout scripts and models are part of the customer configuration.

PL product is a representation of a physical price label that tights the PL model, PL layout script and PL type together.

Each PL in a store is coupled to a certain PL product and may be chosen from a number of different PLs. This is what the user envisions as a PL. As mentioned above PL types, PL layout scripts and PL models are associated with a PL product and are grouped together at the same level under the PL product in a file tree view.

When configuring a new PL model to a PL product only the PL layout scripts applicable for that PL product are available and when associating a PL with a PL model only the PL model associated to that PL product are available.

Generally PL model and PL layout script concern mapping of data and PL type concerns the physical characteristics of the price label.

Depending on the requirement from the customer, one may use the PL models differently. A default model may be used, that results in a one-to-one relationship between physical price labels and PL models. If different PLs are required to display different information for the same item, different models have to be defined and selected when linking the PLs to the item.

A PL model refers to the following objects in the price label server: Price label product,

PL layout scripts (both price and information register), Item Presentation Forms (both price and information register) and Overlay type and layout (if that option is used).

In FIG. 5 there is one set of PLs associated with “Model A” and another set of PLs associated with “Model B”. Each model comprises a table that specifies what layout scripts to run for the PLs depending on the IPF set for that item. For the PLs associated with “Model A” and if IPF is set to “normal price”, the layout scripts “Play2” and “Ilay2” is to be used to the price register and the information register, respectively. Also a script to be used when printing the overlay “Olay2” is stored in the table.

Similar, for the PLs associated with “Model B” the layout scripts “PlayY”, “IlayY” and “OlayY” are used.

The different models described in connection with FIG. 5 could have been used to display e.g. local currency on the PLs associated with “Model A” and Euro for the others. The information that is displayed is, as already mentioned, controlled by the layout scripts. The “Y” layout script would then have to be written in a way that converts the price in local currency into the Euro counterpart.

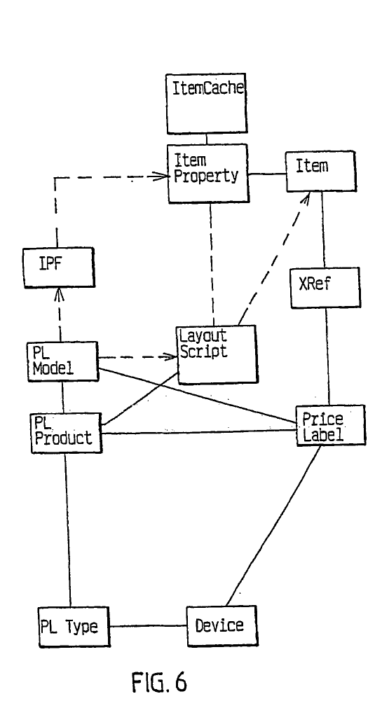

FIG. 6 shows a more detailed block diagram illustrating the relationships between different hardware and software objects according to the present invention.

The Item and cross-reference, Xref, tables, together with the physical price labels, Price Label, are dynamic objects where the item table via Xref links each physical price label to the other objects. These other objects may be regarded as static objects whereas they are subject to changes only when the system is configured, both initially when the system is set up and when the system is updated e.g. new PL models or types are added.

A typical system may comprise about 10000 price labels, each individually controlled by the system.

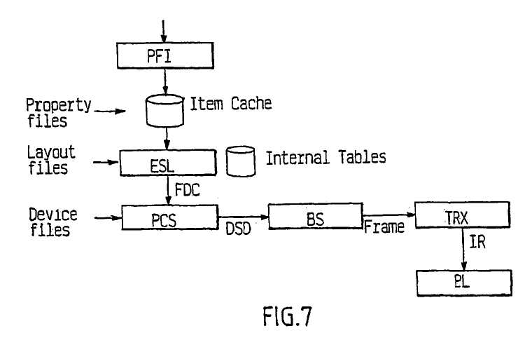

An ItemCache database stores data received from the PCA. In ItemProperty a property description file is arranged that contains item data and information how the data should be viewed in a graphical user interface (not shown in the figure). The Item Presentation Form (IPF) table comprises a high-leveled description of the kind of information to be displayed on the Price Label. The other blocks in FIG. 6 are described above and in relation with the description of FIG. 7.

FIG. 7 shows the main blocks of the price label system according to the present invention.

The system comprises a price file interface (PFI) where data, e.g. new price of an item, is received in the form of a PFI data file from the store's PCA-system (not shown in the figure). The received data is stored in an item cache database and a request to create an update job is generated. A property description file contains item data and information how the data should be viewed in a graphical user interface (GUI) in a client (not shown in the figure) connected to the server. The request for updating a PL is applied to the “electronic shelf edge label” management block (ESL) that handles the connection between item and price label by accessing item and label information from the item cache database and also from internal tables in the ESL-block. To determine which information to send out to an individual PL, the PL's associated PL layout script file is executed based on information in the associated PL model, using the IPF to select the appropriate layout script. The layout script files describe how to map item data onto the price label. There are a number of layout script files for each PL type. When the layout script is executed, the output from the layout script is transformed into a format called “field data contents” (FDC) containing the data to send.

The FDCs are collected in a batch in the “price communication service” (PCS) block. The PCS block converts, by using “device files” and by using the settings in an associated communication protocol, the FDC data to frames which are collected into a “device specific data” (DSD) that in turn is transferred to a sending queue. The “device flies” define how to display the data on the label. There is one device file for each PL type. The PL product representing the physical PL associates the model, the layout script and the PL type.

DSDs from the sending queue are then transmitted to the basestation (BS) and her in the form of data frames via the transceivers (TRX) sent by IR light to the price labels (PLs).

Below is an overview of the price changing process in a price label system according to a preferred embodiment of the present invention:

1. The price label system server from the store's PCA-system receives a price file containing item number and the new information, e.g. price.

2. Look up the item in a database and get the identity of all price labels (PLs) connected to this item.

3. Get the PL model to be used. Either as a specified property on the PL or else use the default model for that PL type.

4. Determine which layout script to use based on the IPF for the item.

5. Execute the layout scripts, and perform all the steps needed to generate the data frame that is to be transmitted to the target PL.

6. Determine in which sub-cell the PL is located. This could be either the sub-cell where a price label acknowledge last was received or the subcell initiated by the PCA-system. In this determined sub-cell the frame containing e.g. price information will be transmitted.

7. Fetch the communication settings from the communication protocol object associated with the determined sub-cell. This is determined through the communication profile of that sub-cell.

8. Transmit the frame to a base-station and flirter to the transceivers in the determined sub-cell for communication to the price label(s) using the communication parameters specified in the protocol object.

The present invention is not limited to the above-described preferred embodiments. Various alternatives, modifications and equivalents may be used. Therefore, the above embodiments should not be taken as limiting the scope of the invention, which is defined by the appending claims.

1. Price label system comprising price label system server adapted to communicate with a price controlling application (PCA) server communicating price label information to price labels (PLs), wherein the characteristics of a price label is depending on price label types, price label layout scripts and price label models, characterised in that the system comprises a price label product, being a representation of a physical price label, that links together the price label type, price label layout script and price label model for a specific price label.

2. Price label system according to claim 1, characterised in that said price label product, price label type, price label layout script and price label model are tables, databases or preferably relational databases.

3. Price label system according to any preceding claim, characterised in that said price label type describes the physical characteristics for a price label, e.g. communication protocol parameters used when communicating with the label, LCD display segments and how they are grouped.

4. Price label system according to any preceding claim, characterised in that said price label layout script describes how to map item data on the label.

5. Price label system according to any preceding claim, characterised in that said price label model contains information about how to select price label layout script based on information sent to the system from price controlling application server.

6. Price label system according to any preceding claim characterised in that said price label information includes numerical values, text, figures and/or images.

7. Price label system according to any preceding claim characterised in that the price label product object is a level higher than price label type, price label layout and price label model in a file tree view.

8. Method of configuring a price label system according to any preceding claim, characterised in that said method comprises the following steps:
defining at least one price label model including price label layout scripts to be used on price label(s) for a specific item in a store;
associating said price label model(s) and at least one price label type(s) to a price label product representing said price label(s).

9. Computer program product directly loadable into the internal memory of a processing unit in a price label system server, comprising the software code portions for performing the steps performed by the price label server or by the method according to of any of claims 1-8, when said product is run on a price label system server.

10. Computer program product stored on a computer usable medium, comprising a readable program for causing a processing unit in a price label system server, to control an execution of the steps performed by the price label server or by the method according to of any of claims 1-8.
